(19) United States
(12) Patent Application Publication
(10) Pub. No.: US 2025/0191829 A1
(43) Pub. Date: Jun. 12, 2025

(54) ISOLATION TRANSFORMER PACKAGES WITH LAMINATED WINDING STRUCTURES

(71) Applicant: Allegro MicroSystems, LLC, Manchester, NH (US)

(72) Inventors: Paul A. David, Bow, NH (US); Andrew Thompson, Cheshire (GB)

(73) Assignee: Allegro MicroSystems, LLC, Manchester, NH (US)

(21) Appl. No.: 18/533,527

(22) Filed: Dec. 8, 2023

(51) Int. Cl. H01F 27/28; H01F 27/02; H01F 27/24; H01F 27/32; H01F 41/04

(52) U.S. Cl. CPC H01F 27/2804; H01F 27/022; H01F 27/24; H01F 27/323; H01F 41/046

(57) ABSTRACT

Aspects of the present disclosure include systems, structures, circuits, and methods providing laminated winding structures with coil portions for transformers. Transformer packages can include substrates with winding portions that connect to laminated winding structures to form complete transformer coils configured about a transformer core. The laminated winding structures can include spaces to receive a transformer core when mounted on a substrate. The packages and modules may include various types of circuits; in some examples, chip packages or modules may include a galvanically isolated gate driver or other high voltage circuit.

### BACKGROUND

Solid state switches typically include a transistor structure. The controlling electrode of the switch, usually referred to as its gate (or base), is typically controlled (driven) by a switch drive circuit, sometimes also referred to as gate drive circuit. Such solid state switches are typically voltage-controlled, turning on when the gate voltage exceeds a manufacturer-specific threshold voltage by a margin, and turning off when the gate voltage remains below the threshold voltage by a margin.

Switch drive circuits typically receive their control instructions from a controller such as a pulse-width-modulated (PWM) controller via one or more switch driver inputs. Switch drive circuits deliver their drive signals directly (or indirectly via networks of active and passive components) to the respective terminals of the switch (gate and source).

Some electronic systems, including ones with solid state switches, have employed galvanic isolation to prevent undesirable DC currents flowing from one side of an isolation barrier to the other. Such galvanic isolation can be used to separate circuits in order to protect users from coming into direct contact with hazardous voltages.

Various transmission techniques are available for signals to be sent across galvanic isolation barriers including optical, capacitive, and magnetic coupling techniques. Magnetic coupling typically relies on use of a transformer to magnetically couple circuits on the different sides of the transformer, typically referred to as the primary and secondary sides, while also providing galvanic separation of the circuits.

Transformers used for magnetic-coupling isolation barriers typically utilize a magnetic core to provide a magnetic path to channel flux created by the currents flowing in the primary and secondary sides of the transformer. Magnetic-coupling isolation barriers have been shown to have various drawbacks, including manufacturing problems, for integrated circuit (IC) packages due to the included magnetic core.

### SUMMARY

Aspects of the present disclosure are directed to isolation transformer packages having laminated winding structures.

One general aspect of the present disclosure includes a transformer package including: a substrate with opposed first and second surfaces and including a first plurality of conductive traces (structure), where the first plurality of conductive traces includes a first plurality of coil portions; a magnetic core disposed on the first surface of the substrate, where the magnetic core includes a soft ferromagnetic material; and a winding structure disposed on the substrate and covering the magnetic core, where the winding structure includes a body including insulator material and a second plurality of coil portions configured for connection to the first plurality of coil portions, where the winding structure defines a cavity configured to receive the magnetic core; where the first plurality of coil portions and the second plurality of coil portions, when in contact, form first and second coils disposed about the magnetic core, where the first and second coils and magnetic core are configured as a transformer.

Implementations may include one or more of the following features. The transformer package may include an encapsulant material configured to form or define a package body or one or more surfaces of a package body, where the encapsulant material covers the winding structure. The encapsulant material may include, e.g., a molding material. The first plurality of conductive traces (structures) can include first and second lead sets presenting exposed portions for electrical connection outside of the package body. Any suitable conductive materials may be used for the first and second plurality of conductive traces, e.g., copper, aluminum, etc. The winding structure may include a preformed structure. The winding structure is configured to provide a space between an interior surface of the cavity and an exterior surface of the magnetic core. The space may include a gap between the interior surface of the cavity and the exterior surface of the magnetic core. The transformer package may include at least one semiconductor die disposed on the substrate. The at least one semiconductor die may include an integrated circuit (IC). The IC may include a gate driver. The first and second coils can be configured as primary and secondary coils in a step-up configuration, with the gate driver being connected to the secondary coil. The magnetic core may include ferrite. The substrate may include a printed circuit board (PCB). The winding structure may include a PCB or PCB structure. The PCB, of winding structure and/or substrate, may include FR4, FR5, or other PCB material(s).

Another general aspect of the present disclosure includes a method of making an integrated circuit (IC) and transformer package. The method includes: providing a substrate with opposed first and second surfaces and including a first plurality of conductive traces, where the first plurality of conductive traces includes a first plurality of coil portions; providing a magnetic core disposed on the first surface of the substrate, where the magnetic core includes a soft ferromagnetic material; and providing a winding structure disposed on the substrate and covering the magnetic core, where the winding structure includes a body including insulator material and a second plurality of coil portions configured for connection to the first plurality of coil portions, where the winding structure defines a cavity configured to receive the magnetic core; where the first plurality of coil portions and the second plurality of coil portions, when in contact, form first and second coils disposed about the magnetic core, where the first and second coils and magnetic core are configured as a transformer.

Implementations may include one or more of the following features. The method may include forming a package body including an encapsulant, where the encapsulant is configured to cover the winding structure. The encapsulant may include a molding material. The package body may include mold material. Providing the winding structure may include connecting the first plurality of coil portions disposed in the substrate with the second plurality of coil portions included in the winding structure. The substrate may include a printed circuit board (PCB). The magnetic core may include ferrite. The method may include providing one or more semiconductor die that are supported by the substrate. The one or more semiconductor die may include first and second semiconductor die having first and second integrated circuits (ICs), respectively, and where the first and second coils are connected to the first and second ICs, respectively. The first and second ICs can be galvanically isolated. The second IC may include a gate driver, e.g., configured to control a semiconductor power switch.

A further general aspect of the present disclosure includes a voltage-isolated integrated circuit (IC) package. The voltage-isolated integrated circuit package includes a substrate having first and second opposed surfaces and a first plurality of conductive traces, where the first plurality of conductive traces includes a first plurality of coil portions; a magnetic core disposed on a first surface of the substrate, where the magnetic core includes a soft ferromagnetic material; a winding structure disposed on the substrate and covering the magnetic core, where the winding structure includes a body including insulator material and a second plurality of coil portions configured for connection to the first plurality of coil portions, where the winding structure defines a cavity configured to receive the magnetic core; where the first plurality of coil portions and the second plurality of coil portions, when in contact, form first and second coils disposed about the magnetic core, where the first and second coils and magnetic core are configured as a transformer; first and second IC die connected to the first and second coils, respectively; a first plurality of leads (conductive structures) connected to the first IC die; and a second plurality of leads (conductive structures) connected to the second IC die.

Implementations may include one or more of the following features. The IC package may include an encapsulant material covering the winding structure disposed on the substrate. The encapsulant material may include a molding material. The encapsulant material can be configured to define one or more surfaces of a package body. The second IC die may include a gate driver. The transformer can be configured as a step-up transformer, step down transformer, or a power transformer. The magnetic core can include ferrite. The substrate may include a printed circuit board (PCB). The winding structure may include a printed circuit board (PCB).

The features and advantages described herein are not all-inclusive; many additional features and advantages will be apparent to one of ordinary skill in the art in view of the drawings, specification, and claims. Moreover, it should be noted that the language used in the specification has been selected principally for readability and instructional purposes, and not to limit in any way the scope of the present disclosure, which is susceptible of many embodiments. What follows is illustrative, but not exhaustive, of the scope of the present disclosure.

### BRIEF DESCRIPTION OF THE DRAWINGS

The manner and process of making and using the disclosed embodiments may be appreciated by reference to the figures of the accompanying drawings. In the figures like reference characters refer to like components, parts, elements, or steps/actions; however, similar components, parts, elements, and steps/actions may be referenced by different reference characters in different figures. It should be appreciated that the components and structures illustrated in the figures are not necessarily to scale, emphasis instead being placed upon illustrating the principals of the concepts described herein. Furthermore, embodiments are illustrated by way of example and not limitation in the figures, in which:

FIGS. 1A-1C each show top and side section views, respectively, of an example laminated winding structure 100 at different stages of fabrication, in accordance with the present disclosure;

FIGS. 2A-2B show side views of a transformer package having laminated winding structures at different stages of fabrication, in accordance with the present disclosure;

FIGS. 3A-3B are diagrams showing an example transformer-based integrated circuit (IC) package having laminated winding structures in an unassembled state and an assembled state, respectively, in accordance with the present disclosure; and

FIG. 4 is a diagram showing an example method of fabricating a transformer-based integrated circuit (IC) package having laminated winding structures, in accordance with the present disclosure.

### DETAILED DESCRIPTION

The features and advantages described herein are not all-inclusive; many additional features and advantages will be apparent to one of ordinary skill in the art in view of the drawings, specification, and claims. Moreover, it should be noted that the language used in the specification has been selected principally for readability and instructional purposes, and not to limit in any way the scope of the inventive subject matter. The subject technology is susceptible of many embodiments. What follows is illustrative, but not exhaustive, of the scope of the subject technology.

Aspects of the present disclosure are directed to and include systems, structures, circuits, and methods providing transformers and transformer structures that can be used for galvanic isolation (a.k.a., voltage isolation). Some embodiments and examples can include laminated winding structures used with a core in a transformer configuration. In some embodiments, a transformer with laminated winding structure may have, e.g., a step up, a step down, or a power transformer configuration. Some embodiments and examples can include integrated circuit (IC) packages or modules with laminated winding structures.

The packages and modules may include various types of circuits; in some examples, IC packages or modules may include a galvanically isolated gate driver or other high voltage circuit, etc. One or more (e.g., first and second) IC die (a.k.a., semiconductor die) having one or more ICs can be included in the packages. Such integrated circuits can include, e.g., but are not limited to, high-voltage circuits such as galvanically-isolated gate drivers configured to drive an external gate on a solid-state (semiconductor) switch, e.g., a field effect transistor (FET), a metal oxide semiconductor FET (MOSFET), a metal semiconductor FET (MESFET), a gallium nitride FET (GaN FET), a high electron mobility transistor (HEMT), a silicon carbide FET (SIC FET), an insulated gate bipolar transistor (IGBT), or another load.

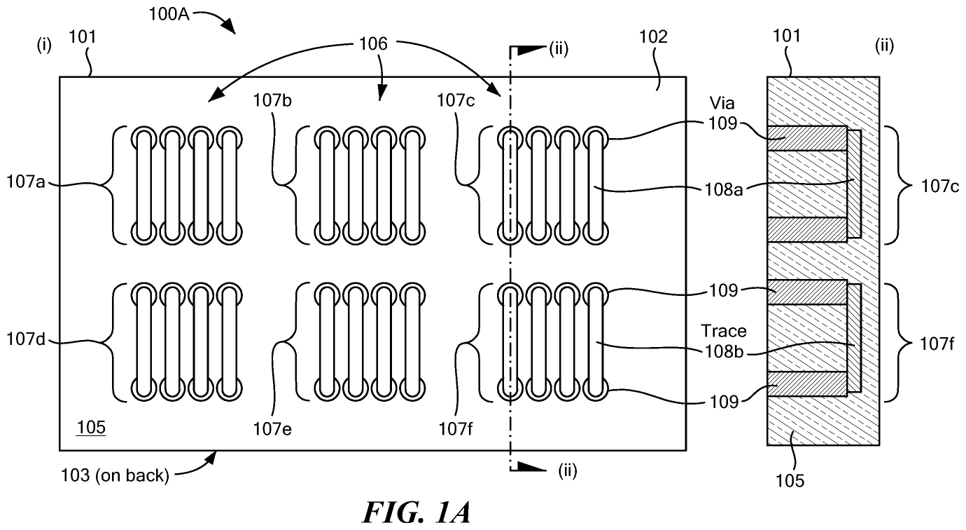

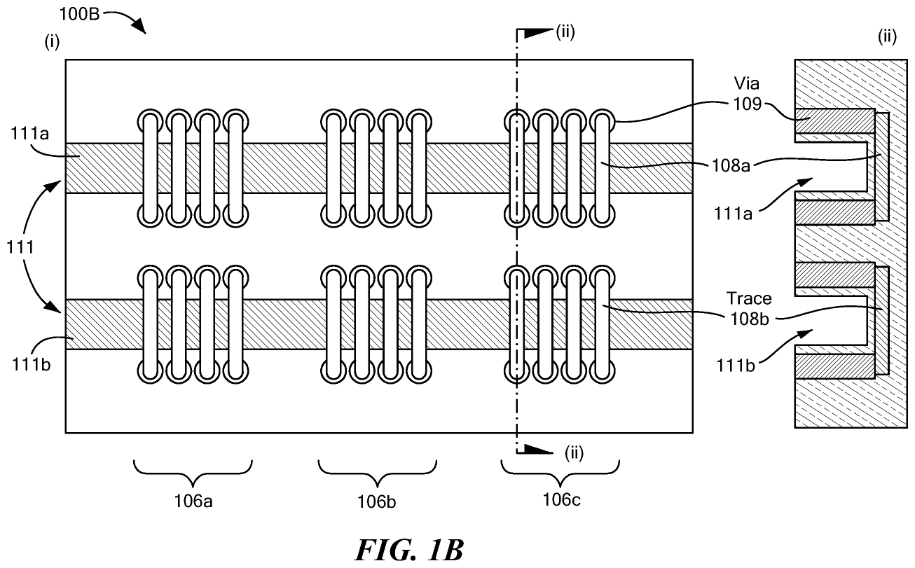

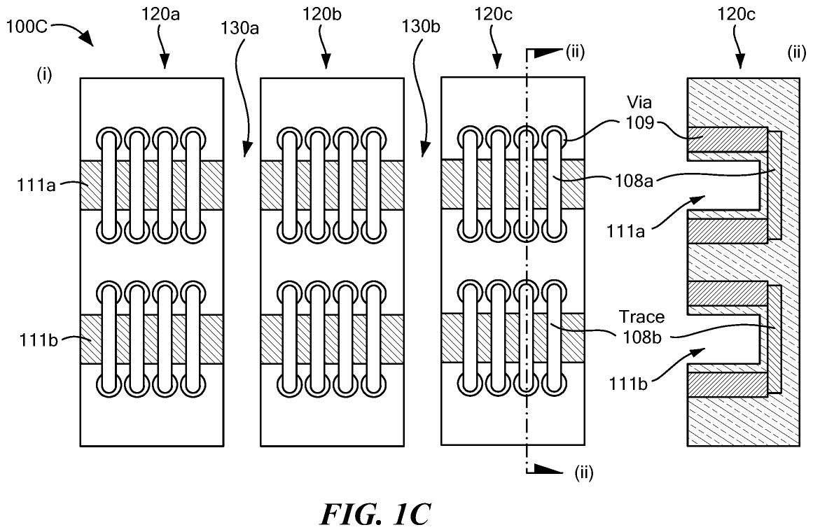

FIGS. 1A-1C each show top and side section views (i)-(ii), respectively, of an example laminated winding structure 100 at different stages of fabrication (100A, 100B, 100C), in accordance with the present disclosure. Structure 100 can include a substrate 101 having opposed first and second surfaces (sides) 102, 103. In example embodiments, substrate 101 can include suitable laminate substrate material 105, e.g., a printed circuit board (PCB), a glass substrate with alternating layers of glass and metal, etc. For embodiments utilizing PCB as a laminated substrate, any suitable PCB material may be used, e.g., FR4, FR5, etc. View (i) in each of FIGS. 1A-1C has a portion of the substrate material 105 removed from the top of substrate 101 to show buried conductive structures.

As shown in FIG. 1A, structure 100A includes substrate 101 with regions 106 having a plurality of conductive structures 107 (shown as 107a-f), which are for use as portions of first and second transformer coils, as described in further detail below. Conductive structures 107 (shown as 107a-f) can include one or more traces 108 (shown as 108a and 108b for first and second coil portions, respectively) and vias 109.

As shown in FIG. 1B, for structure 100B, a portion of substrate material 105 can be removed in regions 111 between vias 109. Regions 111a, 111b are shown for respective coil portions (of first and second coils) 107a, 107b, respectively. Material removal for regions 111 may be accomplished by any suitable method/technique, e.g., milling, deep reactive ion etching (DRIE), laser cutting/milling, etc. Regions 111 are configured (e.g., designed and made) to fit around and accept a given magnetic core for a transformer package, as is described in further detail below.

FIG. 1C shows structure 100C that has been partitioned or sectioned into separate laminated winding structures 120a-120c. Partition/separation areas 130-b are shown between separated (singulated) laminated winding structures 120a-120b and 120b-120c, respectively. Partitioning/separating may be accomplished by any suitable method/technique, e.g., milling, sawing, laser cutting, etc.

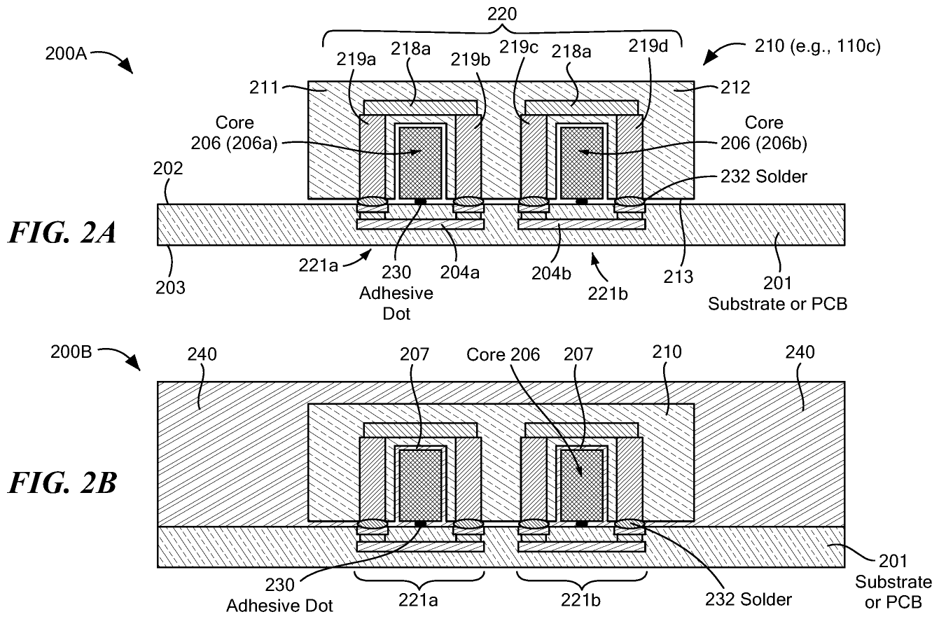

FIGS. 2A-2B show side views of a transformer package structure 200 having laminated winding structures at different stages of fabrication (200A, 200B), in accordance with the present disclosure.

Structure 200 includes a first substrate (e.g., PCB) 201 and a laminated winding structure 210 having a second substrate 211. First substrate 201 can include any suitable substrate, e.g., PCB, a glass substrate with alternating layers of glass and metal, a molded leadframe, a ceramic substrate, etc. Second substrate 211 can include a suitable laminate substrate, e.g., a PCB substrate, glass substrate with alternating layers of metal, etc., having first and second sides 212, 213. For embodiments utilizing PCB for first substrate 201 and/or second substrate 211, any suitable PCB material may be used, e.g., FR4, FR5, etc. In some embodiments, laminated winding structure 210 can be the same as or similar to substrate structure 110c in FIG. 1C. In some embodiments, laminated winding structure 210 can be affixed to first substrate 201 with suitable adhesive, shown as adhesive dots 230. Structure 200A in FIG. 2A is shown omitting any encapsulation or protective layer.

Package structure 200 can include transformer 220 with a core 206 (shown with cross-sections 206a-206b). Core 206 is shown positioned between first substrate 201 and laminated winding structure 210 within space 207. Core 206 may have a closed shape, e.g., a toroidal or rectangular shape. In some embodiments, core 206 may include soft ferromagnetic material, e.g., ferrite, nickel, a nickel alloy such as iron nickel (FeNi), SiFe (ferrosilicon), etc. In some embodiments, a sintered soft ferromagnetic material can be used for core 206. In some embodiments, space 207 may be filled with suitable protective and/or insulative material (e.g., a compliant silicone material, etc.) after core 206 is positioned in space 207.

Transformer 220 can include first (primary) and second (secondary) coils 221a-b that are formed from winding portions disposed in the first and second substrates 201, 211. As shown, first substrate 201 can include a plurality of conductive structures, e.g., traces 204a-b and associated posts, that form portions (e.g., “first portions”) of first and second coils 221a-b of transformer 220. Laminated winding structure 210 can include a plurality of conductive structures, e.g., conductive traces 218a-b and vias 218a-d, which form complementary portions (e.g., “second portions”) of the first and second coils 221a-b. When connected, e.g., as shown by solder connections 232, the first and second coil portions form complete first and second coils 221a-b, each having a desired number of windings. In some embodiments, transformer 220 can be configured as a step up transformer with second coil 221b being on the higher voltage side.

As shown in FIG. 2B, structure 200B may optionally include an encapsulant (encapsulate) material 240, e.g., in a layer. Encapsulant 240 can cover laminated winding structure and/or first substrate 201. Any suitable material can be used for encapsulant 240. In some embodiments, encapsulant 240 can include a molding material.

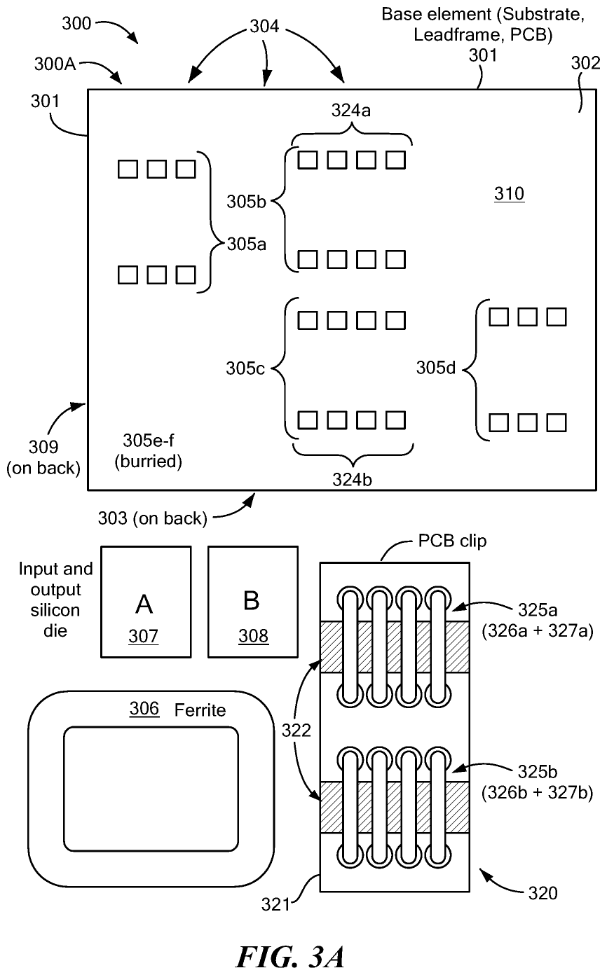

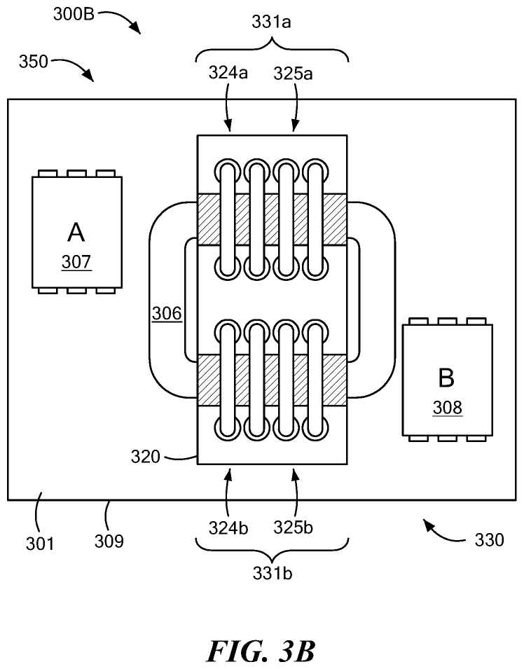

FIGS. 3A-3B are diagrams showing an example transformer-based integrated circuit (IC) package 300 having laminated winding structures in an unassembled state 300A and an assembled state 300B, respectively, in accordance with the present disclosure.

As shown in FIG. 3A, package structure 300A can include a substrate 301 having first and second opposed sides 302, 303. Substrate 301 can include a plurality of conductive structure 304. Conductive structures 304 can include multiple sets of pads 305a-d and buried traces 305e-f. In some embodiments, the conductive structures 304 (e.g., including 305a-d and 305e-f) can be configured as sets of galvanically isolated conductive structures corresponding to first and second sides of a transformer, respectively, as described below. A set of conductive structure (e.g., including pads 305b and connected buried traces) can form portions 324a (e.g., “first coil portions” or “first plurality of coil portions”) of a first coil (e.g., a primary coil) of transformer package structure 300A. Another set of conductive structures (e.g., including pads 305c and connected buried traces) can form portions 324b (e.g., “first coil portions” or “first plurality of coil portions”) of a second coil (e.g., a secondary coil) of transformer package structure 300A. In some embodiments substrate 301 can include a plurality of conductive structures for input/output (I/O) connections 309, e.g., a land grid array (LGA), as indicated for side 303.

Structure 300A can include a magnetic core 306 and first and second IC die (shown as IC packages) 307, 308. Core 306 can include one or more soft ferromagnetic materials, e.g., ferrite. In some embodiments, core 306 may have a closed shape, e.g., a toroidal shape as shown.

Package structure 300A can also include a laminated winding structure 320, e.g., similar to 110c in FIG. 1C. Laminated winding structure 320 can include a laminated substrate 321, e.g., a PCB. Substrate 321 can have volumes/spaces 322 that are configured to received (fit around) core 306. Substrate 321 can also have portions 325a (e.g., “second coil portions” or “second plurality of coil portions”) of one coil (e.g., a first coil) of transformer package structure 300A and portions 325b (e.g., “second coil portions” or “second plurality of coil portions”) of another (e.g., a second coil) of transformer package structure 300A. Coil portions 325a can include traces 326a and vias 327a. Coil portions 325b can include traces 326b and vias 327b.

FIG. 3B shows transformer package structure 300B with components of transformer package 300A assembled (integrated) to form transformer-based IC package 350. For package 350, laminated winding structure 320 is shown mounted to first substrate 301 at pads 305b and 305c. Laminated winding structure is also shown fitting over core 306, which is mounted to first substrate 301. Package 350 includes transformer 330 formed by first and second coils 331a, 331b and core 306. First and second coils 331a, 331b are formed by first coil portions 324a-b (of substrate 301) being in contact (connected to) second coil portions 325a-b (of laminated winding structure 320). IC die 307, 308 are shown mounted to substrate 301 at locations of pads 305a and 305d, respectively.

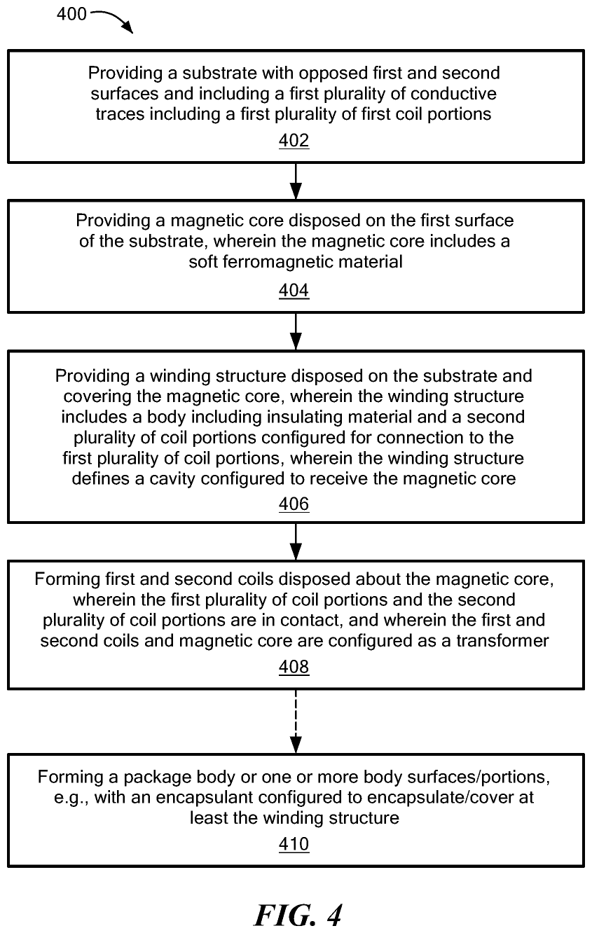

FIG. 4 is a diagram showing an example method 400 of fabricating a transformer package having laminated winding structures, in accordance with the present disclosure. Method 400 can include providing a substrate with opposed first and second surfaces and including a first plurality of conductive traces including a first plurality of first coil portions, as described at 402. A magnetic core can be provided that is disposed on the first surface of the substrate, with the magnetic core including a soft ferromagnetic material, as described at 404. Any suitable soft ferromagnetic material(s) may be used for the magnetic core. A laminated winding structure can be provided that is disposed on the substrate and covering the magnetic core, wherein the winding structure includes a body including insulator material and a second plurality of coil portions configured for connection to the first plurality of coil portions, wherein the winding structure defines a cavity configured to receive the magnetic core, as described 406. The first plurality of coil portions and the second plurality of coil portions, can be placed into contact, forming first and second coils disposed about the magnetic core, with the first and second coils and magnetic core configured and operational as a transformer, as described at 408.

As an optional step, a package body or one or more portions/surfaces of a package body may be formed, e.g., with an encapsulant material such as a molding material, that is/are configured to cover at least the winding structure, as described at 410. An encapsulant material may also cover at least a portion of the surface of the substrate and/or the transformer and may define one or more surfaces of the package body. In some embodiments, an insulator material can be provided to the magnetic core to provide isolation. In some embodiments, the core may be insulated with an insulating tape on the core side(s)/surface(s) facing an adjacent substrate or structure.

In some examples, an isolation transformer package may include one or more (e.g., first and second) ICs forming a transformer-based IC package. Two or more ICS can accordingly be galvanically isolated by the included transformer structure, with the first and second coil portions forming primary and secondary coils for the transformer. The primary and secondary coils (and any connected IC die) along with connecting conductive structure can form primary (input) and secondary (output) sides, respectively, of a transformer. As noted above, in some embodiments and examples, the secondary side may be a high voltage side, e.g., with the transformer configured as a step up transformer.

In some examples and/or embodiments, ICs (e.g., in die 307 and 308 shown in FIG. 3), or other conductive features of the primary and secondary sides of a transformer, can be fabricated or configured to have a desired separation distance (d) between certain parts or features, e.g., to meet internal creepage or external clearance requirements for a given pollution degree rating as defined by certain safety standards bodies such as the Underwriters Laboratories (UL) and the International Electrotechnical Commission (IEC). For example, a separation distance may be between closest (voltage) points of the respective circuits, e.g., the low-voltage (primary) side and high-voltage (secondary) side. For further example, such a separation distance may be the distance between any two voltage points between the primary and secondary sides, e.g., distance between conductive traces of the (main) substrate (e.g., 301 in FIG. 3), or a distance between die, or a distance between exposed leads of a package (or unpackaged substrate), may be or may be at least 1.2 mm, 1.4 mm, 1.5 mm, 3.0 mm, 4.0 mm, 5.5 mm, 7.2 mm, 8.0 mm, 10 mm, or 10+mm in respective examples. Such a distance between conductive portions or areas of die can include any insulation covering a conductor, e.g., such as plastic coating of a wire/lead. Other distances between conductive parts, components, and/or features of an IC package may also be designed and implemented, e.g., to meet desired internal creepage, voltage breakdown, or external clearance requirements, e.g., between external leads.

In some examples and embodiments, a dielectric material (e.g., gel) may be used for potting and/or protecting substrate (e.g., PCB) systems, assemblies, packages (e.g., such as IC and/or transformer package or modules), to protect die and/or interconnects from environment conditions and/or to provide dielectric insulation. In some embodiments, a suitable dielectric material can include a non-gel material. In some examples, a dielectric material may include, but is not limited to, one or more of the following materials: DOWSIL™ EG-3810 Dielectric Gel (made available by The Dow Chemical Corporation, a.k.a., “Dow”, and DOWSIL™ EG-3896 Dielectric Gel (made available by Dow), which has the ability to provide isolation greater than 20 kV/mm. DOWSIL™ EG-3810 is designed for temperature ranges from −60° C. to 200° C. and DOWSIL™ EG-3896 Dielectric Gel −40° C. to +185° C.; both of which can be used to meet typical temperature ranges for automotive applications. Other suitable gel and/or dielectric materials may also or instead be used, e.g., to meet or facilitate meeting/achieving voltage isolation specifications required by a given package design.

Accordingly, embodiments and/or examples of the inventive subject matter can afford various benefits relative to prior art techniques. For example, embodiments and examples of the present disclosure can enable or facilitate use of smaller size packages for a given power or voltage rating. Embodiments and examples of the present disclosure can enable or facilitate lower costs and higher scalability for manufacturing of IC packages/modules having voltage-isolated IC die and transformers.

Various embodiments of the concepts, systems, devices, structures, and techniques sought to be protected are described above with reference to the related drawings. Alternative embodiments can be devised without departing from the scope of the concepts, systems, devices, structures, and techniques described. For example, primary and secondary transformer coils of a transformer package may each have a whole number or fractional number of turns (windings or loops of conductor/conductive material about a related core or structure intended to receive a core), e.g., 1.5, 2.5, 1.75, 1.8, 2.25, 6.4, 12.33, etc.

It is noted that various connections and positional relationships (e.g., over, below, adjacent, etc.) may be used to describe elements and components in the description and drawings. These connections and/or positional relationships, unless specified otherwise, can be direct or indirect, and the described concepts, systems, devices, structures, and techniques are not intended to be limiting in this respect. Accordingly, a coupling of entities can refer to either a direct or an indirect coupling, and a positional relationship between entities can be a direct or indirect positional relationship.

As an example of an indirect positional relationship, positioning element “A” over element “B” can include situations in which one or more intermediate elements (e.g., element “C”) is between elements “A” and elements “B” as long as the relevant characteristics and functionalities of elements “A” and “B” are not substantially changed by the intermediate element(s).

Also, the following definitions and abbreviations are to be used for the interpretation of the claims and the specification. The terms “comprise,” “comprises,” “comprising,” “include,” “includes,” “including,” “has,” “having,” “contains” or “containing,” or any other variation are intended to cover a non-exclusive (a.k.a., open-ended) inclusion. For example, an apparatus, a method, a composition, a mixture, or an article, which includes a list of elements is not necessarily limited to only those elements but can include other elements not expressly listed or inherent to such apparatus, method, composition, mixture, or article.

Additionally, the term “exemplary” means “serving as an example, instance, or illustration.” Any embodiment or design described as “exemplary” is not necessarily to be construed as preferred or advantageous over other embodiments or designs. The terms “one or more” and “at least one” indicate any integer number greater than or equal to one, i.e., one, two, three, four, etc.; however, those terms may refer to fractional numbers where context admits, e.g., a number of loops, turns, or windings in a transformer coil (e.g., coil structure or winding structure) may be a fractional value, e.g., 1.66, 2.75, 3.5, 4.25, etc. The term “plurality” indicates any integer number greater than one; however, a “plurality” may refer to fractional numbers where context admits, e.g., a number of loops, turns, or windings in a transformer coil (e.g., coil structure or winding structure) may be a fractional value e.g., 1.66, 2.75, 3.5, 4.25, etc. The term “connection” can include an indirect “connection” and a direct “connection.”

References in the specification to “embodiments,” “one embodiment, “an embodiment,” “an example embodiment,” “an example,” “an instance,” “an aspect,” etc., indicate that the embodiment described can include a particular feature, structure, or characteristic, but every embodiment may or may not include the particular feature, structure, or characteristic. Moreover, such phrases do not necessarily refer to the same embodiment. Further, when a particular feature, structure, or characteristic is described in connection with an embodiment, it may affect such feature, structure, or characteristic in other embodiments whether explicitly described or not.

Relative or positional terms including, but not limited to, the terms “upper,” “lower,” “right,” “left,” “vertical,” “horizontal, “top,” “bottom,” and derivatives of those terms relate to the described structures and methods as oriented in the drawing figures. The terms “overlying,” “atop,” “on top, “positioned on” or “positioned atop” mean that a first element, such as a first structure, is present on a second element, such as a second structure, where intervening elements such as an interface structure can be present between the first element and the second element. The term “direct contact” means that a first element, such as a first structure, and a second element, such as a second structure, are connected without any intermediary elements.

Use of ordinal terms such as “first,” “second,” “third,” etc., in the claims to modify a claim element does not by itself connote any priority, precedence, or order of one claim element over another, or a temporal order in which acts of a method are performed but are used merely as labels to distinguish one claim element having a certain name from another element having a same name (but for use of the ordinal term) to distinguish the claim elements.

The terms “approximately” and “about” may be used to mean within +20% of a target (or nominal) value in some embodiments, within plus or minus (±) 10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

The disclosed subject matter is not limited in its application to the details of construction and to the arrangements of the components set forth in the following description or illustrated in the drawings. The disclosed subject matter is capable of other embodiments and of being practiced and carried out in various ways.

Also, the phraseology and terminology used in this patent are for the purpose of description and should not be regarded as limiting. As such, the conception upon which this disclosure is based may readily be utilized as a basis for the designing of other structures, methods, and systems for carrying out the several purposes of the disclosed subject matter. Therefore, the claims should be regarded as including such equivalent constructions as far as they do not depart from the spirit and scope of the disclosed subject matter.

Although the disclosed subject matter has been described and illustrated in the foregoing exemplary embodiments, the present disclosure has been made only by way of example. Thus, numerous changes in the details of implementation of the disclosed subject matter may be made without departing from the spirit and scope of the disclosed subject matter.

Accordingly, the scope of this patent should not be limited to the described implementations but rather should be limited only by the spirit and scope of the following claims.

All publications and references cited in this patent are expressly incorporated by reference in their entirety.

What is claimed is:

1. A transformer package comprising:
a substrate with opposed first and second surfaces and including a first plurality of conductive traces, wherein the first plurality of conductive traces includes a first plurality of coil portions;
a magnetic core disposed on the first surface of the substrate, wherein the magnetic core includes a soft ferromagnetic material; and
a winding structure disposed on the substrate and covering the magnetic core, wherein the winding structure includes a body including insulator material and a second plurality of coil portions configured for connection to the first plurality of coil portions, wherein the winding structure defines a cavity configured to receive the magnetic core;
wherein the first plurality of coil portions and the second plurality of coil portions, when in contact, form first and second coils disposed about the magnetic core, wherein the first and second coils and magnetic core are configured as a transformer.

2. The transformer package of claim 1, further comprising an encapsulant material configured to form a package body, wherein the encapsulant material covers the winding structure.

3. The transformer package of claim 2, wherein the encapsulant material comprises a molding material.

4. The transformer package of claim 1, wherein the winding structure comprises a preformed structure.

5. The transformer package of claim 1, wherein the winding structure is configured to provide a space between an interior surface of the cavity and an exterior surface of the magnetic core.

6. The transformer package of claim 5, wherein the space comprises a gap between the interior surface of the cavity and the exterior surface of the magnetic core.

7. The transformer package of claim 1, further comprising at least one semiconductor die disposed on the substrate.

8. The transformer package of claim 7, wherein the at least one semiconductor die comprises an integrated circuit (IC).

9. The transformer package of claim 8, wherein the IC comprises a gate driver.

10. The transformer package of claim 9, wherein the first and second coils are configured as primary and secondary coils in a step-up configuration, and wherein the gate driver is connected to the secondary coil.

11. The transformer package of claim 1, wherein the magnetic core comprise ferrite.

12. The transformer package of claim 1, wherein the substrate comprises a printed circuit board (PCB).

13. The transformer package of claim 1, wherein the winding structure comprises a PCB.

14. The transformer package of claim 13, wherein the PCB comprises FR4.

15. The transformer package of claim 2, wherein the first plurality of conductive traces includes first and second lead sets presenting exposed portions for electrical connection outside of the package body.

16. A method of making an integrated circuit (IC) and transformer package, the method comprising:
providing a substrate with opposed first and second surfaces and including a first plurality of conductive traces, wherein the first plurality of conductive traces includes a first plurality of coil portions;
providing a magnetic core disposed on the first surface of the substrate, wherein the magnetic core includes a soft ferromagnetic material; and
providing a winding structure disposed on the substrate and covering the magnetic core, wherein the winding structure includes a body including insulator material and a second plurality of coil portions configured for connection to the first plurality of coil portions, wherein the winding structure defines a cavity configured to receive the magnetic core;
wherein the first plurality of coil portions and the second plurality of coil portions, when in contact, form first and second coils disposed about the magnetic core, wherein the first and second coils and magnetic core are configured as a transformer.

17. The method of claim 16, further comprising forming a package body including an encapsulant, wherein the encapsulant is configured to cover the winding structure.

18. The method of claim 17, wherein the encapsulant comprises a molding material.

19. The method of claim 16, wherein providing the winding structure comprises connecting the first plurality of coil portions disposed in the substrate with the second plurality of coil portions included in the winding structure.

20. The method of claim 16, wherein the substrate comprises a printed circuit board (PCB).

21. The method of claim 16, wherein the magnetic core comprise ferrite.

22. The method of claim 17, wherein the package body comprises mold material.

23. The method of claim 16, further comprising providing one or more semiconductor die supported by the substrate.

24. The method of claim 23, wherein the one or more semiconductor die comprise first and second semiconductor die comprising first and second integrated circuits (ICs), respectively, and wherein the first and second coils are connected to the first and second ICs, respectively.

25. The method of claim 24, wherein the first and second ICs are galvanically isolated.

26. The method of claim 24, wherein the second IC comprises a gate driver.

27. A voltage-isolated integrated circuit (IC) package comprising:
a substrate having first and second opposed surfaces and a first plurality of conductive traces, wherein the first plurality of conductive traces includes a first plurality of coil portions;
a magnetic core disposed on a first surface of the substrate, wherein the magnetic core includes a soft ferromagnetic material;
a winding structure disposed on the substrate and covering the magnetic core, wherein the winding structure includes a body including insulator material and a second plurality of coil portions configured for connection to the first plurality of coil portions, wherein the winding structure defines a cavity configured to receive the magnetic core;
wherein the first plurality of coil portions and the second plurality of coil portions, when in contact, form first and second coils disposed about the magnetic core, wherein the first and second coils and magnetic core are configured as a transformer;
first and second IC die connected to the first and second coils, respectively;
a first plurality of leads connected to the first IC die; and
a second plurality of leads connected to the second IC die.

28. The IC package of claim 27, further comprising an encapsulant material covering the winding structure disposed on the substrate.

29. The IC package of claim 28, wherein the encapsulant material comprises a molding material.

30. The IC package of claim 28, wherein the encapsulant material is configured to define one or more surfaces of a package body.

31. The IC package of claim 27, wherein the second IC die comprises a gate driver.

32. The IC package of claim 27, wherein the transformer is configured as a step-up transformer.

33. The IC package of claim 27, wherein the magnetic core includes ferrite.

34. The IC package of claim 27, wherein the substrate comprises a printed circuit board (PCB).

35. The IC package of claim 27, wherein the winding structure comprises a printed circuit board (PCB).
